(19) United States
(12) Patent Application Publication
(10) Pub. No.: US 2004/0000738 A1
(43) Pub. Date: Jan. 1, 2004

(54) Apparatus and method for manufacturing see-through type headrest

(76) Inventor: Yasuo Tanaka, Okayama-city (JP)

Correspondence Address: Phillip L. Kenner, Esq., Renner, Kenner, Greive, Bobak, Taylor & Weber, 1610 First National Tower, Akron, OH, 44308-1456, US

(21) Appl. No.: 10/611,524

(22) Filed: Jul. 1, 2003

(30) Foreign Application Priority Data
Dec. 19, 2000 (JP) 2000-384575

(51) Int. Cl. B29C 44/14

(52) U.S. Cl. 264/46.6; 425/4 R; 264/267

(57) ABSTRACT

An apparatus for manufacturing a see-through type headrest comprising a doughnut-shaped surface material 11 having a see-through hole 16 passing through its center part and a foamed body integrated with the surface material 11 by injecting and expanding a foaming material inside the surface material 11. The apparatus 20 comprises an upper mold 21, a lower mold 22, and a core block 30 having an outline corresponding to the see-through hole 16 of the headrest. The core block 30 is detachable from the upper and lower molds 21, 22, and a space corresponding to an outline of the headrest is formed inside those molds 21, 22 when the core block 30 is positioned in the upper or lower mold 21, 22 and the upper and lower molds 21, 22 are then clamped. A skin-skeleton assembly 10 is set in the apparatus 20. A foaming material is injected into an inner space 12 of the surface material 11 through a nozzle inserted and attached to a mouth 15.

### TECHNICAL FIELD

This invention relates to an apparatus and a method for manufacturing a see-through type headrest attached to a car seat

### BACKGROUND OF THE ART

A headrest having a see-through hole passing through its center part is attached to a car seat. Such a headrest is hereinafter referred to as a see-through type headrest. The see-through hole improves the visual range of both a passenger sit on a rear seat and a driver. The see-through type headrest comprises a doughnut-shaped surface material and a foamed body integrated with the surface material by injecting and expanding a foaming material inside the surface material. The surface material is provided by sewing pieces together. The surface material is provided with a hole corresponding to the see-through hole and is also provided with a slot formed on its bottom. An upper part of a U-shaped stay as a framework or skeleton of the see-through type headrest is inserted in the surface material through the slot. The framework of the see-through type headrest includes a holder plate for holding the surface material. The holder plate has an upper plate and a lower plate connected in parallel to the upper plate so as to form a gap between those plates. Such a holder plate is disclosed in Japanese Patent Publication No. Heisei 3(1991)-295617 (by the same applicant as that of the present application). The holder plate has two holes and is attached to the stay by passing two legs of the stay through those holes. An edge portion of the slot is inserted in the gap between the upper and lower plates of the holder plate, and the surface material is thereby held in the holder plate attached to the stay. The holder plate has an injector attaching mouth. An injector nozzle for injecting the foaming material is inserted through and attached to the mouth, and the foaming material such as urethane is injected inside the surface material. The foaming material expands and cures inside the surface material, so that the foamed body is integrated with the surface material and the slot of the surface material is securely closed.

In the prior art, such a see-through type headrest is manufactured by use of an apparatus as shown in FIG. 4, as disclosed in the above Japanese Patent Publication. As shown in FIG. 1, a doughnut-shaped surface material 11 having a see-through hole 11 passing through its center part and a slot on its bottom is provided by sewing pieces together. An upper part of a U-shaped stay 13 is inserted in an inner space 12 of the surface material 11 through the slot A holder plate 14 is attached to the stay 13 by passing two legs of the stay 11 through two holes of the holder plate 14. An edge portion of the slot is inserted in a gap between an upper plate and a lower plate of the holder plate 14, so that the surface material 11 is held in the holder plate 14 attached to the stay 13, and thereby, a skin-skeleton assembly 10 shown in FIG. 1 is completed. This assembly 10 is set in the apparatus 40 shown in FIG. 4. The holder plate 14 has an injector attaching mouth 15. An injector nozzle (not shown) for injecting a foaming material is inserted through and attached to the mouth 15, before or after setting the assembly 10 in the apparatus 40. Inserting the stay in the surface material, inserting the edge of the slot in the gap of the holder plate and attaching the injector nozzle to the injector attaching mouth are carried out by hand, respectively.

The assembly 10 is set in the apparatus 40 shown FIG. 4. Setting the assembly 10 in the apparatus 40 is carried out by hand. The apparatus 40 comprises an upper mold 41 and a lower mold 42. The upper and lower molds 41, 42 have cavities 43, 44, respectively. As shown, the lower mold 42 is provided with a large protrusion 45 corresponding to a see-through hole 16 of the surface material 11, and this large protrusion 45 is fixed in the lower mold 42. Such a large protrusion may be provided in the upper mold 41. When those molds 41, 42 are clamped, an inner space corresponding to an outline of the headrest is formed by the cavities 43, 44. The assembly 10 is set in the lower mold 42 so as to fit the see-through hole 16 of the surface material 11 in the large protrusion 45. Thereafter, the upper and lower molds 41, 42 are clamped, and the assembly 10 is thereby set in the apparatus 40.

A foaming material such as urethane is injected in the inner space 14 of the surface material 11 through an injector nozzle (not shown) attached to the injector attaching mouth 15 of the holder plate 14. The foaming material expands and cures inside the surface material 11, so that a foamed body made of the foaming material is integrated with the surface material 11. Then, this article is released from the apparatus 40, and the see-through type headrest is thereby manufactured.

If the see-through hole 16 of the surface material 11 does not accurately fit in the large protrusion 45 when the assembly 10 is set in the lower mold 42, the surface material 11 about the see-through hole 16 is creased after the foaming material expands and cures inside the surface material 11. Also, the foaming material leaks through stitches about the see-through hole 16. This makes its appearance worse.

Accordingly, setting the skin-skeleton assembly in the lower mold is very delicate and takes much time, so that the throughput is reduced.

### SUMMARY OF THE INVENTION

An object of this invention is to provide a see-through type headrest manufacturing apparatus and method wherein a surface material having a see-through hole passing through its center can be easily and accurately set in the apparatus.

A see-through type headrest to be manufactured according to the present invention comprises a doughnut-shaped surface material having a see-through hole passing through its center part and a foamed body integrated with the surface material by injecting and expanding a foaming material inside the surface material. The surface material is provided by sewing pieces together. According to the present invention, an apparatus for manufacturing a see-through type headrest comprises an upper mold, a lower mold, and a core block having an outline corresponding to the see-through hole of the see-through type headrest The core block is detachable from the upper and lower molds, and a space corresponding to the final desired shape of the see-through type headrest is formed inside those molds when the core block is positioned in the upper or lower mold and the upper and lower molds are then clamped.

The apparatus includes means for positioning the core block inside the upper and lower molds. Preferably, the positioning means comprises a positioning protrusion or a positioning pole provided in at least one of the upper and lower molds and a positioning hollow or a positioning hole provided in the core block to receive the positioning protrusion or the positioning pole.

The core block capable of separating from the upper and lower molds can be manufactured by use of a known molding apparatus such as a foam molding apparatus and an injection molding apparatus. In practice, one or more such core blocks are used for manufacture of the see-through type headrest. The core block is fitted in the see-through hole of the surface material before the surface material is set in the manufacturing apparatus. Then, after the headrest is manufactured, the core block is released from the see-through hole of the surface material integrated with the foamed body expanded inside the surface material. Then, this core block can be repeatedly used for the next surface material.

According to the present invention, a see-through type headrest is manufactured as follows. A doughnut-shaped surface material having a see-through hole passing through its center part and a slot on its bottom is provided by sewing pieces together. An upper part of a U-shaped stay is inserted in an inner space of the surface material through the slot A holder plate is attached to the stay by passing two legs of the stay through two holes of the holder plate. An edge portion of the slot is inserted in a gap between an upper plate and a lower plate of the holder plate, so that the surface material is held in the holder plate attached to the stay. Then, the core block described above is fitted in the see-through hole of the surface material, and thereby, a skin-skeleton-core assembly is completed. This assembly is set in the apparatus according to the present invention. The holder plate has an injector attaching mouth. An injector nozzle for injecting a foaming material is inserted through and attached to the mouth, before or after setting the assembly in the apparatus. Inserting the stay in the surface material, inserting the edge of the slot in the gap of the holder plate, fitting the core block in the see-through hole and attaching the injector nozzle to the injector attaching mouth are carried out by hand, respectively.

It is easily made to confirm whether the core block is securely fitted in the see-through hole of the surface material. Such a confirmation can be made to merely rotate the skin-skeleton-core assembly.

The skin-skeleton-core assembly is set in the apparatus according to the present invention. Setting the assembly in the apparatus is carried out by hand. The assembly is set in the apparatus by merely positioning the core block of the skin-skeleton-core assembly at a predetermined position of the upper or lower mold and clamping the upper and lower molds.

Then, a foaming material such as urethane is injected in the inner space of the surface material through an injector nozzle attached to the injector attaching mouth of the holder plate. The foaming material expands and cures inside the surface material, so that a foamed body made of the foaming material is integrated with the surface material. Then, this article is released from the apparatus, and the see-through type headrest is thereby manufactured. The core block can be released when or after the see-through type headrest is released from the apparatus.

The invention conducts the following effects.

It is easily made to confirm whether the core block is securely fitted in the see-through hole of the surface material. Such a confirmation can be made to merely rotate the skin-skeleton-core assembly.

It is securely and speedily made to set the skin-skeleton-core assembly in the see-through type headrest manufacturing apparatus by merely positioning the core block of the assembly at a predetermined position in the upper or lower mold of the apparatus and clamping those molds.

The apparatus includes means for positioning the core block therein, and thereby, it can be securely and speedily made by not only a skilled person but also a person who does not have enough skill to set the skin-skeleton-core assembly in the see-through type headrest manufacturing apparatus by merely positioning the core block of the assembly at a predetermined position in the upper or lower mold of the apparatus and clamping those molds.

### BRIEF DESCRIPTION OF DRAWINGS

FIG. 1 is a front view of a skin-skeleton assembly of a see-through type headrest

FIGS. 2A and 2B are sectional views of an apparatus according to the present invention, respectively.

FIGS. 3A and 3B are sectional views of an apparatus according to the present invention, respectively.

FIGS. 4A and 4B are sectional views of an apparatus according to the prior art, respectively.

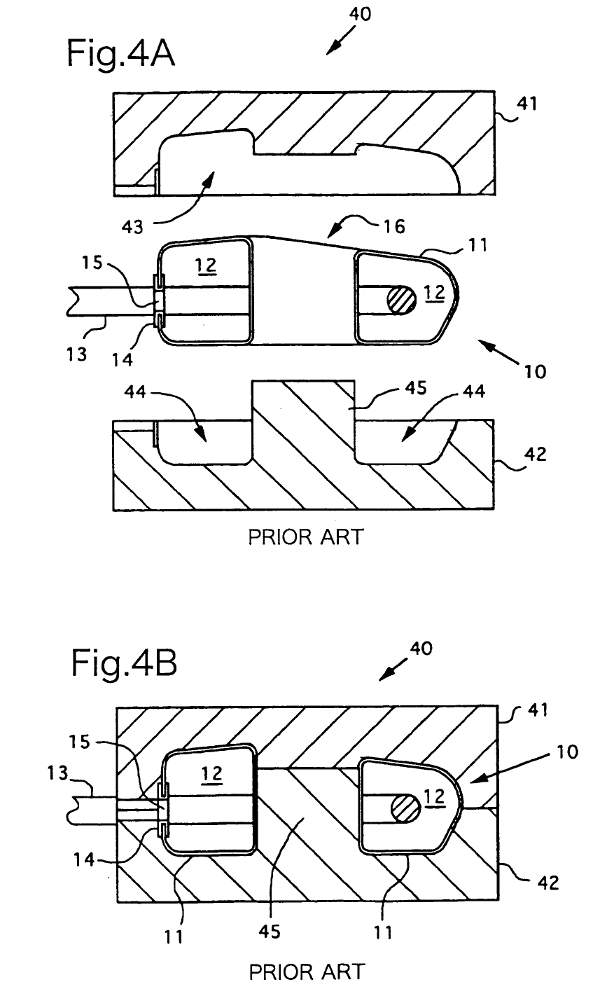

FIGS. 5A and 5B are sectional views of an apparatus for manufacturing a core block shown in FIGS. 2A and 2B, respectively.

FIGS. 6A and 6B are sectional views of an apparatus for manufacturing a core block shown in FIGS. 3A and 3B, respectively.

### DETAILED DESCRIPTION OF THE INVENTION

<See-Through Type Headrest Manufacturing Apparatus>

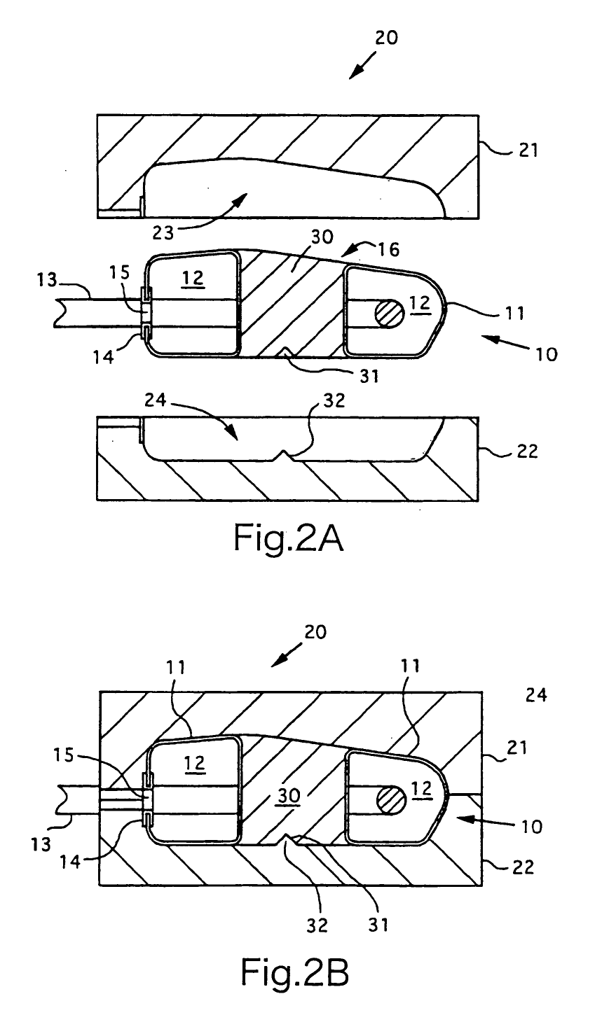

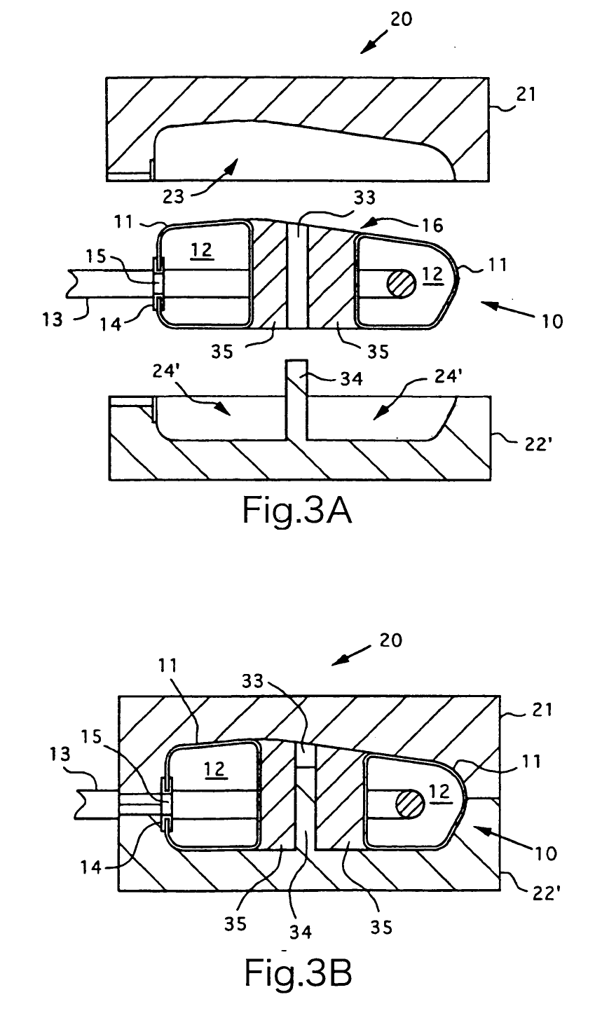

A see-through type headrest manufacturing apparatus of the invention is shown in FIG. 2 (and FIG. 3). As shown, the apparatus 20 comprises an upper mold 21, a lower mold 22 (22′), and a core block 30 (35) having an outline corresponding to a see-through hole 16 of the see-through type headrest. The core block 30 (35) is detachable from the upper and lower molds 21, 22 (22′). The core block 30 (35) has an outline corresponding to a see-through hole 16 of a surface material 11 integrated with a foamed body of the see-through type headrest. Each mold 21, 22 (22′) has a cavity 23, 24 (24′), and a space corresponding to the final desired shape of the see-through type headrest is formed inside those molds when the core block 30 (35) is positioned in the upper or lower mold 21, 22 (22′) and the upper and lower molds 21, 22 (22′) are then clamped.

The apparatus 20 includes means for positioning the core block 30 (35) in the upper and lower molds 21, 22 (22′). In the apparatus 20 shown in FIGS. 2A and 2B, the positioning means comprises a positioning protrusion 32 provided in the lower mold 22 and a positioning hollow 31 provided in the core block 30 to receive the positioning protrusion 32. As shown in FIG. 2B, the protrusion 32 of the lower mold 22 is received in the hollow 31 of the core block 30 fitted in the see-through hole 16 of a skin-skeleton assembly 10 (that is, the see-through hole 16 of the doughnut-shaped surface material 11 held in a holder plate 14 attached to a U-shaped stay 13). Thereby, the skin-skeleton assembly 10 with the core block 30 is securely positioned in the apparatus 20. Meanwhile, in the apparatus 20 shown in FIGS. 3A and 3B, the positioning means comprises a positioning pole 34 provided in the lower mold 22′ and a positioning hole 33 provided in the core block 30 to insert the positioning pole 33 therein. As shown in FIG. 3B, The positioning pole 34 of the lower mold 22′ is inserted in the positioning hole 33 of the core block 35 fitted in the see-through hole 16 of a skin-skeleton assembly 10 (that is, the see-through hole 16 of the doughnut-shaped surface material 11 held in a holder plate 14 attached to a U-shaped stay 13). In FIGS. 2 and 3, the positioning protrusion 32 and the positioning pole 34 are provided in the lower mold 22, 22′, respectively. Alternatively, the positioning protrusion 32 and the positioning pole 34 may be provided in the upper mold 21, respectively.

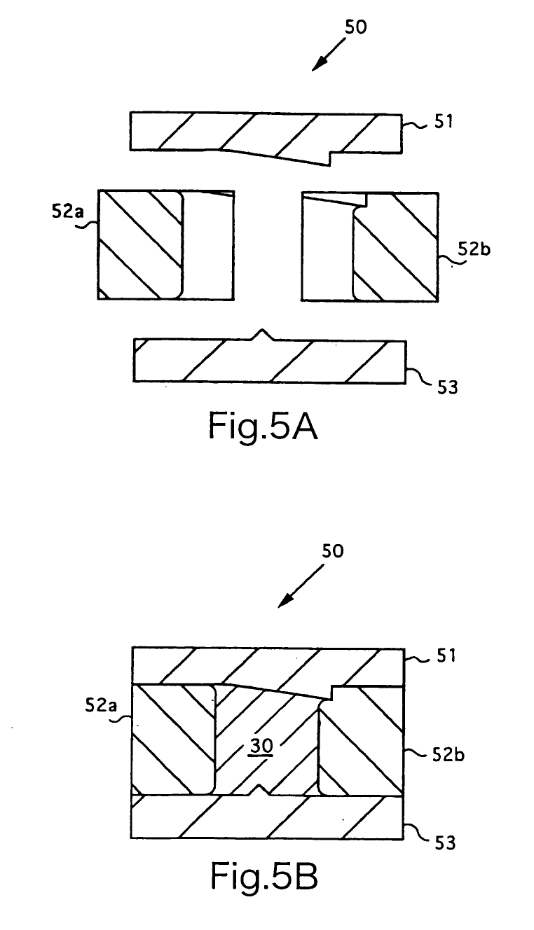

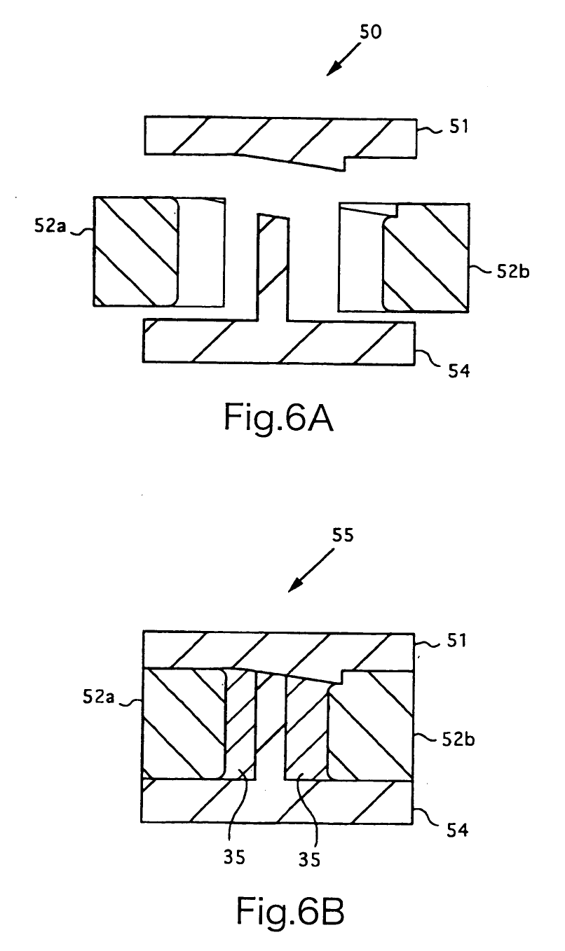

Such a core block 30 (35) can be manufactured by use of a foam molding apparatus or an injection molding apparatus. The core block 30 shown in FIGS. 2A and 2B is manufactured by use of a molding apparatus as shown in FIGS. 5A and 5B. As shown, the molding apparatus 50 comprises an upper mold 51, a lower mold 53 and two split molds 52a, 52b. When those molds 51, 52a, 52b, 53 are clamped, a space corresponding to the core block 30 is formed therein. Meanwhile, the core block 35 shown in FIGS. 3A and 3B is manufactured by use of a molding apparatus shown in FIGS. 6A and 6B. As shown, the molding apparatus 55 comprises an upper mold 51, a lower mold 54 and two split molds 52a, 52b. The lower mold 54 is provided with a pole portion corresponding to the positioning hole 33 of the core block 35. When those molds 51, 52a, 52b, 54 are clamped, a space corresponding to the core block 35 is formed therein. In FIGS. 5 and 6, two split molds 52a, 52b are used in each molding apparatus 50, 55. Alternatively, more than two split molds may be used.

The core block 30 (35) is made of a material selected from a group consisting of: metal or alloy selected from aluminum, iron and the like; foaming, thermoplastic and thermosetting resin selected from urethane, elastomer, ABS, polypropylene, polyester, styrene, PVC, POM, nylon, epoxy and the like; ceramics; and glass. The desirable material is foaming urethane resin or polypropylene resin, because the weight of the core block is reduced and the wear resistance thereof is improved.

Wax, silicon or fluoric lubricant is desirably coated on the core block 30 to easily release the core block 30 from the see-through hole 16 of the surface material 11.

In practice, one or more such core blocks 30 (35) are used for manufacture of the see-through type headrest. The core block 30 (35) is fitted in the see-through hole 16 of the surface material 11 before the surface material 11 is set in the manufacturing apparatus 20. Then, after the headrest is manufactured, the core block 30 (35) is released from the see-through hole 16 of the surface material 11 integrated with the foamed body expanded inside the surface material 11. Then, this core block 30 (35) can be repeatedly used for the next surface material.

<See-Through Type Headrest Manufacturing Method>

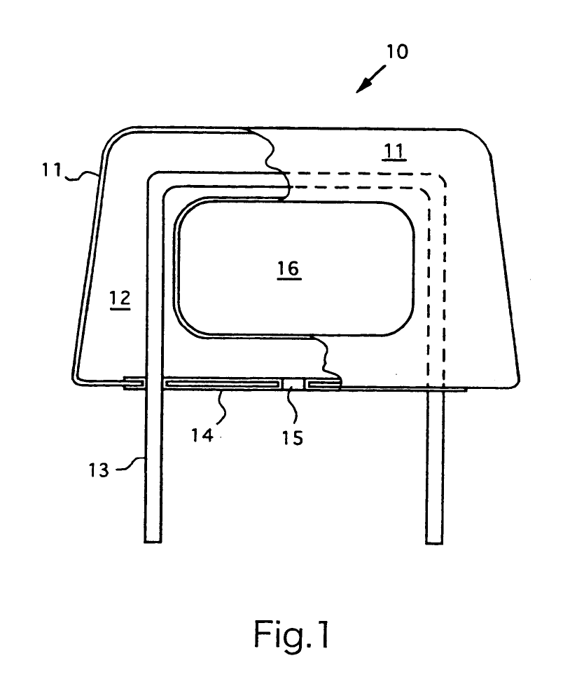

A see-through type headrest is manufactured as follows. As shown in FIG. 1, a doughnut-shaped surface material 11 having a see-through hole 16 passing through its center part and a slot on its bottom is provided by sewing pieces together. An upper part of a U-shaped stay 13 is inserted in an inner space 12 of the surface material 11 through the slot A holder plate 14 is attached to the stay 13 by passing two legs of the stay 13 through two holes of the holder plate 14. An edge portion of the slot is inserted in a gap between an upper plate and a lower plate of the holder plate 14, so that the surface material 11 is held in the holder plate 14 attached to the stay 13, and thereby, a skin-skeleton assembly 10 is completed. Then, the core block 30 (35) described above is fitted in the see-through hole 16 of the surface material 11, and thereby, a skin-skeleton-core assembly is completed. This assembly is set in the apparatus 20 according to the present invention. The holder plate 14 has an injector attaching mouth 15. An injector nozzle (not shown) for injecting a foaming material is inserted through and attached to the mouth 15, before or after setting the assembly in the apparatus 20. The holder plate 14 may be attached to the stay 13 before or after the stay 13 is inserted in the inner space 12 of the surface material through the slot thereof. Inserting the stay 13 in the surface material 11, inserting the edge of the slot in the gap of the holder plate 14, fitting the core block 30 (35) in the see-through hole 16 and attaching the injector nozzle to the injector attaching mouth 15 are carried out by hand, respectively.

It is easily made to confirm whether the core block 30 (35) is securely fitted in the see-through hole 16 of the surface material 11. Such a confirmation can be made to merely rotate the skin-skeleton-core assembly.

The skin-skeleton-core assembly is set in the apparatus 20 according to the present invention (shown in FIG. 2 or 3). Setting the assembly in the apparatus 20 is carried out by hand. The assembly is set in the apparatus 20 by merely positioning the core block 30 (35) of the skin-skeleton-core assembly at a predetermined position of the upper or lower mold 21, 22 (22′) and damping the upper and lower molds 21, 22 (22′).

Then, as well as in the prior art, a foaming material such as urethane is injected in the inner space 12 of the surface material 11 through an injector nozzle (not shown) attached to the injector attaching mouth 15 of the holder plate 14. The foaming material expands and cures inside the surface material 11, so that a foamed body made of the foaming material is integrated with the surface material 11. Then, this article is released from the apparatus 10, and the see-through type headrest is thereby manufactured. The core block 30 (35) can be released when or after the see-through type headrest is released from the apparatus 20. Releasing the core block 30 (35) from the see-through type headrest can be easily made by use of hand.

What we claim is:

1. An apparatus for manufacturing a see-through type headrest said see-through headrest comprising a doughnut-shaped surface material having a see-through hole passing through its center part and a foamed body integrated with said surface material by injecting and expanding a foaming material inside said surface material,
the apparatus comprising:
an upper mold;
a lower mold; and
a core block having an outline corresponding to said see-through hole of said see-through type headrest,
wherein said core block is detachable from said upper and lower molds, and a space corresponding to the final desired shape of said see-through type headrest is formed inside those molds when said core block is positioned in said upper or lower mold and said upper and lower molds are then clamped.

2. The apparatus of claim 1 including means for positioning said core block inside said upper and lower molds.

3. The apparatus of claim 1 wherein said core block is made of a material selected from a group consisting of metal, alloy, foaming resin, thermoplastic resin, thermosetting resin, ceramics and glass.

4. A molding apparatus for manufacturing a core block used in a see-through type headrest manufacturing apparatus for manufacturing a see-through type headrest, said see-through headrest comprising:
a doughnut-shaped surface material having a see-through hole passing through its center part; and
a foamed body integrated with said surface material by injecting and expanding a foaming material inside said surface material,
said see-through type headrest manufacturing apparatus comprising:
an upper mold;
a lower mold; and
said core block having an outline corresponding to said see-through hole of said see-through type headrest,
wherein said core block is detachable from said upper and lower molds, and a space corresponding to the final desired shape of said see-through type headrest is formed inside those molds when said core block is positioned in said upper or lower mold and said upper and lower molds are then clamped,
the molding apparatus comprising a split mold type molding apparatus, a space corresponding to an outline of said core block being formed inside the molding apparatus.

5. The molding apparatus of claim 4 wherein said split mold type molding apparatus comprising:
an upper mold;
a lower mold; and
two split molds, a space corresponding to an outline of said core block being formed inside those molds.

6. A method for manufacturing a see-through type headrest using a see-through type headrest manufacturing apparatus,
said see-through headrest comprising:
a doughnut-shaped surface material having a see-through hole passing through its center part; and
a foamed body integrated with said surface material by injecting and expanding a foaming material inside said surface material,
said apparatus comprising:
the apparatus comprising:
an upper mold;
a lower mold; and
a core block having an outline corresponding to said see-through hole of said see-through type headrest,
wherein said core block is detachable from said upper and lower molds, and a space corresponding to the final desired shape of said see-through type headrest is formed inside those molds when said core block is positioned in said upper or lower mold and said upper and lower molds are then clamped,
the method comprising the steps of:
providing said surface material having said see-through hole passing through its center part and having a slot in its bottom, by sewing pieces together;
inserting an upper part of a U-shaped stay in an inner space of said surface material through said slot;
attaching a holder plate to said stay by passing two legs of said stay through two holes of said holder plate;
inserting an edge portion of said slot in a gap between an upper plate and a lower plate of said holder plate, so that said surface material is held in said holder plate attached to said stay, thereby completing a skin-skeleton assembly;
fitting said core block in said see-through hole of said surface material of said skin-skeleton assembly, thereby completing a skin-skeleton-core assembly;
setting said skin-skeleton-core assembly in said apparatus, said core block of said skin-skeleton-core assembly being positioned in said upper or lower mold of said apparatus;
clamping said upper and lower molds;
injecting a foaming material in an inner space of said surface material through an injector nozzle inserted through and attached to an injector attaching mouth of said holder plate, so that said foaming material expands and cures inside said surface material, and thereby, said foamed body made of said foaming material is integrated with the surface material; and
releasing said surface material integrated with said foamed body from said apparatus.

7. The method of claim 6 including the step of releasing said core block from said surface material integrated with said foamed body.
